(19) United States
(12) Patent Application Publication
(10) Pub. No.: US 2026/0336904 A1
(43) Pub. Date: Oct. 29, 2026

(54) LAMINATED ANTIMICROBIAL FILM TO IMPROVE THE MICROBIAL SAFETY AND QUALITY OF FOODS

(71) Applicant: The Penn State Research Foundation, University Park, PA (US)

(72) Inventors: Abdelrahim H.A. Hassan, University Park, PA (US); Catherine Nettles Cutter, University Park, PA (US); Brittani L. Bedford, University Park, PA (US)

(73) Assignee: The Penn State Research Foundation, University Park, PA (US)

(21) Appl. No.: 19/655,245

(22) Filed: Apr. 22, 2026

Related U.S. Application Data
(60) Provisional application No. 63/792,990, filed on Apr. 23, 2025.

(51) Int. Cl. B65D 81/28; A01N 25/10; A01N 47/44; A01P 1/00; B65D 65/42; B65D 75/00

(52) U.S. Cl. CPC B65D 81/28; A01N 25/10; A01N 47/44; A01P 1/00; B65D 65/42; B65D 75/002

(57) ABSTRACT

Embodiments relate to materials, and products configured to control the growth of bacteria on food products. Specifically, embodiments relate to an antimicrobial layer including an antimicrobial coating formed from a biopolymer composition including at least one antimicrobial agent (e.g., LAE) at least one polysaccharide, at least one protein, at least one plasticizer, and water. The biopolymer solution may be deposited onto a plastic film to form the antimicrobial layer. The layer may be configured to release at least one antimicrobial agent onto a food product to control or inhibit the growth of microorganisms on the product.

### CROSS-REFERENCE TO RELATED APPLICATIONS

This application claims priority to U.S. Provisional Patent Application No. 63/792,990, which was filed on Apr. 23, 2025. The entirety of this application is incorporated by reference herein.

### STATEMENT REGARDING FEDERALLY SPONSORED RESEARCH DEVELOPMENT

This invention was made with government support under Grant No. NI24HMFPXXXXG039 awarded by the United States Department of Agriculture/NIFA. The Government has certain rights in the invention.

### FIELD

Embodiments relate to compositions, materials, and products configured to control the growth of microorganisms on food products. Specifically, embodiments relate to an antimicrobial layer configured to release at least one antimicrobial agent onto a food product to control the growth of microorganisms on the product.

### BACKGROUND

An essential function of food packaging is reducing and mitigating food spoilage. Food packaging acts as a barrier to the outside world to protect the food from biological, chemical, and physical contaminants or hazards. Food spoilage results from changes in food that render it undesirable for human consumption. Many avenues or mechanisms lead to food spoilage, and such mechanisms may include biological and chemical processes or a result of contact with contaminants that further the production of spoilage processes.

The length of time required for the degradation or spoilage of foods is referred to as “shelf-life.” Shelf-life is often measured by the quality or acceptability of foods by measuring microorganisms, color, odor, flavor, and/or nutritional value. Spoilage organisms can survive and multiply in foods due to optimal pH, nutrient availability, temperature, and water activity levels. Spoilage within food products occurs not only due to microbial growth but also due to the metabolites they produce.

Scientists often use a concept referred to as “Hurdle Technology,” to extend the shelf-life and ensure the safety of food. Hurdle technologies are a mixture of intentional mitigation strategies such as heating and cooling, the addition of preservatives, reducing pH, or controlling water activity in the production of foods to ensure the safety and quality of foods. With “hurdle technology,” good manufacturing practices (GMPs), sanitation, and packaging methods enhance the safety and quality of food during and after production. Although these practices can extend the shelf-life of foods and reduce the risk of contamination, spoilage of packaged foods persists due to microorganisms found within the food matrices.

### SUMMARY

Active packaging or antimicrobial packaging systems can serve as carriers for antimicrobial agents to reduce spoilage organisms' growth, prolong the shelf-life of foods, and reduce contamination by foodborne pathogens. Many antimicrobials are water-soluble and difficult to incorporate into hydrophobic polymers. Polysaccharides and proteins are water-soluble and possess sites of hydrogen bonding formation, making them suitable for incorporating antimicrobials and antioxidants. Resulting films can be used as biobased packaging, biopolymers, edible films, or coatings. Although they are excellent film formers with strong oxygen barrier properties, provide a moisture barrier, and exhibit physical properties of biopolymers, such as tensile strength and puncture resistance, they do not compare to the petroleum-based polymers used for food packaging. Heat-sensitive biopolymers made from polysaccharides and proteins pose the risk of degradation due to the high heat required in standard packaging production processes such as extrusion technologies.

Accordingly, we have developed a composite antimicrobial film (CAF), also referred to as laminated antimicrobial film (LAF), by combining the technology of biopolymer coatings and petroleum-based plastics. A biopolymer layer was created using a polysaccharide-based coating containing a protein and a plasticizer to improve the mechanical properties and adhesion of the coating to a polymer film. In particular, the protein may promote thickening and stability of the coating and improve the mechanical and barrier properties of the dried coating, and the plasticizer may act similarly to the protein, as the component stabilizes the aqueous coating and enhances the coating's rheological properties. The biopolymer layer further includes an antimicrobial agent within the coating.

Embodiments therefore relate to an antimicrobial layer including an antimicrobial coating formed from a biopolymer solution and a plastic film. Embodiments further relate to a method of forming the biopolymer-containing-antimicrobial layer. Embodiments further relate to a method of controlling or inhibiting the growth of microorganisms on food products and/or of increasing the shelf life of food products.

In an exemplary embodiment, an antimicrobial layer comprises an antimicrobial coating formed from a biopolymer solution comprising at least one antimicrobial agent present in an amount up to 5 wt %, at least one polysaccharide present in an amount between 12-15 wt %, at least one protein present in an amount up to5 wt %, at least one plasticizer present in an amount up to 10 wt %, and water present in an amount between 70-80 wt %; a plastic film comprising one or more plastics, wherein at least a portion of the antimicrobial coating is disposed on at least a portion of the plastic film.

In some embodiments, the at least one antimicrobial agent comprises ethyl lauric arginate.

In some embodiments, the at least one polysaccharide comprises pullulan.

In some embodiments, the at least one polysaccharide consist of pullulan.

In some embodiments, the antimicrobial coating does not include xanthan gum.

In some embodiments, the at least one protein comprises gelatin.

In some embodiments, the at least one plasticizer comprises glycerol.

In some embodiments, the one or more plastics comprise ethylene vinyl alcohol.

In an exemplary embodiment, a film comprises the antimicrobial layer.

In some embodiments, the antimicrobial layer is disposed on a food packaging material that is in contact with a food product.

In some embodiments, at least a portion of the antimicrobial coating is in contact with the surface of the food product.

In some embodiments, the film is configured to inhibit growth of at least one microorganism on the food product.

In some embodiments, the film is configured to increase the shelf life of the food product relative to the shelf life of the food product packaged with a comparative layer different than the antimicrobial layer.

In some embodiments, the film is configured to inhibit growth of the at least one microorganism for a period of up to 28 days under refrigeration conditions.

In an exemplary embodiment, a vacuum sealed bag comprises the antimicrobial layer.

In an exemplary embodiment, a method of forming an antimicrobial layer comprises providing a plastic film comprising one or more plastics; depositing a biopolymer solution onto the plastic film, the biopolymer solution comprising at least one antimicrobial agent present in an amount up to 5 wt %, at least one polysaccharide present in an amount between 12-15 wt %, at least one protein present in an amount up to 5 wt %, at least one plasticizer present in an amount up to 10 wt %, and water present in an amount between 70-80 wt %; and drying the biopolymer solution to form an antimicrobial coating.

In some embodiments, the method further comprises corona-treating the plastic film prior to depositing the biopolymer solution onto the plastic film.

In some embodiments, drying the biopolymer composition comprises infrared heating the biopolymer solution.

In some embodiments, drying the biopolymer composition further comprises subjecting the biopolymer solution to an air velocity of at least 12 m/s.

In some embodiments, the biopolymer solution is configured to be dried within 10 minutes.

Other details, objects, and advantages of our compositions, materials, and products configured to control the growth of bacteria on food products will become apparent as the following description of certain exemplary embodiments thereof proceeds.

### BRIEF DESCRIPTION OF THE DRAWINGS

The above and other objects, aspects, features, advantages, and possible applications of embodiments of the present innovation will be more apparent from the following more particular description thereof, presented in conjunction with the following drawings. Like reference numbers used in the drawings may identify like components.

FIG. 1 is a schematic illustration of a cross-sectional view of an exemplary antimicrobial layer.

FIG. 2 shows an exemplary embodiment of a method of making an antimicrobial layer.

FIG. 3 is a schematic illustration of a Kilian film line used to develop a pilot-scale manufacturing process.

FIG. 4 is a simplex design plot. The constraint lines represent the design space.

FIG. 5 is a photograph of a drying apparatus developed to simulate pilot-scale processing.

FIG. 6 is a table including mixture proportions of coating components and experimental data of optimization responses.

FIG. 7 is a table including estimated regression coefficients and ANOVA values for each response (component proportions).

FIG. 8 is a contour plot of coating viscosity at a shear rate of 33 1/s at 30 °C The contour lines represent mean values of the viscosity at 33 1/s at 50 °C The border represents the design space of the mixture design; n=2.

FIG. 9 is a contour plot of coating viscosity at a shear rate of 33 1/s at 50 °C The contour lines represent mean values of the viscosity at 33 1/s at 60 °C The border represents the design space of the mixture design; n=2.

FIG. 10 is a contour plot of coating viscosity at a shear rate of 33 1/s at 70 °C The contour lines represent mean values of the viscosity at 33 1/s at 70 °C The border represents the design space of the mixture design; n=2.

FIG. 11 is a mixture contour plot of contact angle. The contour lines represent mean values of the contact angle of each FFS at 50 °C The border represents the design space of the mixture design; n=3.

FIG. 12 is a contour plot of drying time at 50 °C The contour lines represent mean values of the drying time of each FFS at 50 °C The border represents the design space of the mixture design; n=2.

FIG. 13 is a contour plot of drying time at 60 °C The contour lines represent mean values of the drying time of each FFS at 60 °C The border represents the design space of the mixture design; n=2.

FIG. 14 is a contour plot of drying time at 70 °C The contour lines represent mean values of the drying time of each FFS at 70 °C The border represents the design space of the mixture design; n=2.

FIG. 15 is a main effects plot of the effect of temperature (Temp; 25 °C, 50 °C, 60 °C, and 70 °C), formulation (Form) and organism (Organ) type on the inhibition against L. monocytogenes J1-003 (Lm), E. coli O111 (Ec), and S. Typhimurium (ST).

FIG. 16 is an interaction plot demonstrating the interaction between the FFS and drying temperature (25 °C, 50 °C, 60 °C, and 70 °C); FFS and organism type; and drying temperature and organism type; n=4.

FIG. 17 is a contour plot of the total inhibition of LAE against pathogens in plate overlay assays. The contour lines represent sum of the inhibition against L. monocytogenes J1-003, E. coli O111, and S. Typhimurium. The border represents the design space of the mixture design; n=12.

FIG. 18 is an overlaid contour plot of the optimization responses, drying time at 50 °C, contact angle, viscosity at 33 1/s at 50 °C and total inhibition. The line represented the design space of the method.

FIG. 19 is a graph showing transparency of the developed optimized LAFs. The transparency data is presented as three replicates' (n=3), mean values and standard deviations. Those with means that have an asterisk are significantly different *(P<0.01), **(P<0.001), ***(P<0.001), ****(P<0.0001).

FIG. 20 is a graph showing thickness of the developed optimized LAFs. The thickness data is presented as five replicates' (n=5), mean values and standard deviations. Those with means that have an asterisk are significantly different *(P<0.01), **(P<0.001), ***(P<0.001), ****(P<0.0001).

FIG. 21 is a graph showing moisture content of the developed optimized LAF. The moisture content is presented as three replicates (n=3), mean values, and standard deviations. Those with means that have an asterisk are significantly different *(P<0.01).

FIG. 22 is a graph showing swelling of the developed optimized LAF. The swelling is presented as three replicates (n=3), mean values, and standard deviations. Those with means that have an asterisk are significantly different *(P<0.01).

FIG. 23 is a graph showing release kinetics of the optimized LAF containing 0.5% LAE within 50 mL of food simulant A (10% ethanol). The data are presented as the mean and relative standard deviation of three independent replicate. Note: Standard error bars range from +/−0.47 to 0.62 and may not be visible.

### DETAILED DESCRIPTION

The following description is of exemplary embodiments and methods of use that are presently contemplated for carrying out the present invention. This description is not to be taken in a limiting sense but is made merely for the purpose of describing the general principles and features of various aspects of the present invention. The scope of the present invention is not limited by this description.

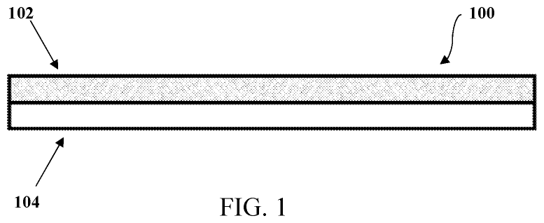

Embodiments generally relate to an antimicrobial layer for use in food packaging. Referring to FIG. 1, an antimicrobial layer 100 may be configured as a composite antimicrobial film (CAF) or laminated antimicrobial film (LAF) including an antimicrobial coating 102 disposed on at least a portion of a plastic film 104. The antimicrobial layer 100 may be used as a food packing material, or as a component of a food packaging material, and be configured to control and/or inhibit the growth of bacteria on food products, such that the shelf life, safety, and/or freshness of the food products may be improved relative to food products contained or otherwise packaged in a different material.

The antimicrobial coating 102 may be formed from a biopolymer solution deposited onto at least a portion of the plastic film 104. The solution includes at least one antimicrobial agent, at least one polysaccharide, at least one protein, and at least one plasticizer.

As used herein, the term “antimicrobial agent” may refer to a compound configured to inhibit the growth of microorganisms, such as bacteria, fungi, and viruses, which can spoil food or cause foodborne illnesses. The antimicrobial agent may be released, such as onto the surface of a food product, from the antimicrobial layer 100 over time. This may be advantageous and more desirable than applying the antimicrobial agent directly onto a food surface, as the antimicrobial agent may then run off and not be as effective in inhibiting the growth of microorganisms. In particular, the antimicrobial agent may be released from the layer in a two-phase pattern: an initial burst followed by sustained release. This release profile may enhance the layer's antimicrobial efficacy.

At least one antimicrobial agent may be selected from the group consisting of organic acids and salts (e.g., acetic acid, acetates, diacetates, lactic acid, lactates, etc.), benzoic acids and benzoates, propionic acid and propionates, citric acid and citrates, sorbic acid and sorbates, sulfur dioxide and sulfites, medium chain fatty acids and monoesters, parabens, dimethyl decarbonate and diethyl decarbonate, transferrins (e.g., lactoferrin, ovotrasferrin), lactolipids, immunoglobulins (ex. lactoglobulins, ovoglobulins, avidin), defensins, chitosan, pleurocidin, casocidin, natamycin, antimicrobial peptides/bacteriocins (e.g., nisin, pediocin, etc.), buffered sodium citrate (BSC), sodium nitrite and nitrate, lysozyme, phyto-chemicals (e.g., essential oils, spices, teas, fruit/vegetable extracts, hops, tannins, etc.), bacteriophage, ethyl lauroyl arginate (LAE), or any other suitable antimicrobial agent, and mixtures thereof. In some embodiments, at least one antimicrobial agent includes LAE. LAE is a broad-spectrum antimicrobial approved for use as a food additive at levels up to 200 ppm by the Food and Drug Administration (FDA). At least one antimicrobial agent may additionally or alternatively include any other suitable antimicrobial agent.

The biopolymer solution may include an effective amount of at least one antimicrobial agent. As used herein, the term “effective amount” is an amount sufficient to bring about a biologically meaningful reduction in the amount or extent of microorganisms, inhibition or prevention of microorganism growth, or destruction (e.g., killing) of microorganisms. In some embodiments, an “effective amount” may refer to an amount of antimicrobial agent sufficient to reduce the amount or extent of microorganisms, inhibit or prevent microorganism growth, or kill microorganisms, relative to a reference value obtained from use of a control solution that does not contain the antimicrobial agent, or contains less of the antimicrobial agent relative to the effective amount.

In some embodiments, the biopolymer solution includes up to 5 wt %, such as greater than 0 wt % but 5 wt % or less, of at least one antimicrobial agent.

The biopolymer solution may include at least one polysaccharide. The polysaccharide is configured to enable the biopolymer solution to adhere to and form a coating on the plastic film. At least one component of the biopolymer also may be selected from groups consisting of starch (e.g., potato, corn, wheat, rice, barley, pea), cellulose (e.g., wood, cotton), gums (e.g., xanthan, guar, locust bean, alginate, carrageenan, pectin), chitosan/chitin and/or include, any other suitable component or mixtures thereof. In some embodiments, the biopolymer includes pullulan. Pullulan is a water-soluble, biodegradable, biocompatible, non-toxic, non-carcinogenic, non-mutagenic and edible polysaccharide. At least one polysaccharide may additionally or alternatively include any other suitable polysaccharide.

In some embodiments, the biopolymer solution includes 12-15% wt % of at least one polysaccharide. As nonlimiting examples, the solution may include at least 12% by weight, at least 13% by weight, at least 14% by weight, and/or the like, of at least one polysaccharide. As further nonlimiting examples, the solution may include no greater than 15% by weight, no greater than 14% by weight, no greater than 13% by weight, and/or the like, of at least one polysaccharide. In one embodiment, the biopolymer solution includes 14.84 wt % of at least one polysaccharide.

In some embodiments, at least one polysaccharide may not include a humectant such as xanthan gum. In particular, the antimicrobial layer may not include xanthan gum. It is contemplated that the xanthan gum may form complexes with the antimicrobial agent (e.g., LAE) and result in a reduction of antimicrobial activity.

The biopolymer solution may also include at least one protein. The protein may be configured to improve the mechanical and physical strength of the resulting coating. At least one protein may be plant-based proteins (e.g., zein, soy, gluten, peanut), animal-based (e.g., albumin, casein, whey, collagen, gelatin), and mixtures thereof. In some embodiments, the protein includes gelatin. At least one protein may additionally or alternatively include any other suitable protein.

In some embodiments, the biopolymer solution includes no greater than 5 wt % of at least one protein, such as greater than 0 wt % but 5 wt % or less, or 2-5 wt % of at least one protein. If the protein is present in amounts of greater than 5 wt %, the resulting coating may be too thick and/or rough once deposited on the plastic film. As nonlimiting examples, the solution may include at least 2% by weight, at least 3% by weight, at least 4% by weight, and/or the like, of at least one protein. As further nonlimiting examples, the solution may include no greater than 5% by weight, no greater than 4% by weight, no greater than 3% by weight, and/or the like, of at least one protein. In one embodiment, the biopolymer solution includes 3.65 wt % of at least one protein.

The biopolymer solution may also include at least one plasticizer. The plasticizer is configured to further improve the mechanical and physical strength of the resulting coating. At least one plasticizer may be selected from the group consisting of waxes, triglycerides, phospholipids, glycerol, or any other suitable plasticizer, and mixtures thereof. In some embodiments, at least one plasticizer may include glycerol. At least one plasticizer may additionally or alternatively include any other suitable plasticizer.

In some embodiments, the biopolymer solution includes no greater than 10 wt % of at least one plasticizer, such as greater than 0 wt % but 10 wt % or less at least one plasticizer. If the plasticizer is present in amounts of greater than 10 wt %, the resulting coating may be too sticky and difficult to handle. As nonlimiting examples, the solution may include at least 0.1% by weight, least 1% by weight, at least 2% by weight, at least 3% by weight, at least 4% by weight, at least 5% by weight, at least 6% by weight, at least 7% by weight, at least 8% by weight, at least 9 3% by weight, and/or the like, of at least one plasticizer. As further nonlimiting examples, the solution may include no greater than 10% by weight, no greater than 9% by weight, no greater than 8% by weight, no greater than 7% by weight, no greater than 6% by weight, no greater than 5% by weight, no greater than 4% by weight, no greater than 3% by weight, no greater than 2% by weight, and/or the like, of at least one plasticizer. In one embodiment, the biopolymer solution includes 5.00 wt % of at least one plasticizer.

The biopolymer solution composition may also include water. In some embodiments, the biopolymer solution includes 70-80 wt % of water. In coating systems, ensuring that the coated solution is of a sufficient viscosity may be important to reduce sagging and promote leveling of the solution during processing. If water is present in amounts greater than 80 wt %, the viscosity may be decreased such that the performance of the solution during manufacturing may be negatively impacted, as there may be a tendency to splatter during leveling or dispensing.

The plastic film 104 may include one or more polymers (e.g., plastics). Plastics may be selected from the group consisting of polyamide (PA), polyethylene (PE), ethylene vinyl alcohol (EVOH), high-density polyethylene (HDPE), low-density polyethylene (LDPE), poly(ethylene-co-vinylacetate) (EVA), poly(ethylene terephthalate) (PET), poly(vinyl chloride) (PVC), polypropylene (PP) (e.g., biaxially-oriented polypropylene, BOPE), polylactic acid (PLA), cellulose, methylcellulose (MC), hydroxypropyl methylcellulose (HPMC), nylon (e.g., Nylon 9), and mixtures thereof, or any other suitable plastic. In some embodiments, the plastics may include PA and PE. In some embodiments, the plastic may include BOPE and EVOH. In some embodiments, the plastic may include PA, BOPE, and EVOH. The plastic film 104 may additionally or alternatively include any other suitable plastic.

In some embodiments, the plastic film 104 includes at least one recyclable plastic. In some embodiments, the plastic film 104 consists only of recyclable plastics.

In some embodiments, the plastic film 104 includes at least one biodegradable plastic. In some embodiments, the plastic film104 consists only of biodegradable plastics.

The antimicrobial layer 100 may be provided in any form, including but not limited to sheets, rolls, and the like. In some embodiments, the layer 100 may be provided as a sachet, or as a bag. In some embodiments, the layer 100 may be sealed in contact with at least a portion of a food surface. In some embodiments, the layer 100 may be used as vacuum packaging, or as a component of vacuum packaging, such that the layer is sealed under vacuum. The antimicrobial layer 100 may therefore be configured to be in contact with a food product. In some embodiments, at least a portion of the antimicrobial coating 102 may be configured to be in contact with a surface of the food product.

In some embodiments, the antimicrobial layer 100 may be non-toxic and/or edible.

In some embodiments, the antimicrobial layer 100 may be used with any food product, particularly any food product that may be susceptible to contamination with microorganisms. Food products may include meats such as, but not be limited to, beef, pork, lamb, goat, venison, bison, rabbit, poultry (e.g., chicken, turkey, duck, etc.), freshwater fish, saltwater fish, shellfish, other game meat (e.g., elk, boar, etc.), or other exotic meat (e.g., alligator). In some embodiments, the meat may be raw or fresh meat. In some embodiments, the meat may be processed/ready-to-eat meat, such as deli meat. Food products may further include, but not be limited to, fruits (or fruit products), vegetables (or vegetable products), nuts (or nut products), dairy (or dairy products). Food products may be a solid, semi-solid, liquid, or semi-liquid product. Food products may be a room temperature product, refrigerated product, or frozen product.

The antimicrobial layer 100 is configured to inhibit the growth of microorganisms. In some embodiments, the inhibition of growth comprises killing the microorganisms. In some embodiments, the inhibition of growth comprises inhibiting formation of colony forming units.

In some embodiments, growth of microorganisms may be inhibited for a period up to 7 days, up to 14 days, up to 21 days, up to 28 days, or longer under refrigeration storage conditions (e.g., at or around 6 °C).

Microorganisms may include bacteria or fungi. Exemplary bacteria may include Gram-positive bacteria and/or Gram-negative bacteria. For example, bacteria may include, but are not limited to, Escherichia coli, Salmonella Typhimurium, Listeria monocytogenes, Staphylococcus aureus, Brochothrix thermosphacta, Fusarium oxysporum, Enterococcus faecalis, Enterobacter spp., lactic acid bacteria, Aspergillus niger, Bacillus coagulans, Bacillus cereus, Klebsiella pneumoniae, etc. Exemplary fungi may include yeast or molds.

In some embodiments, the antimicrobial layer100 may be essentially colorless, odorless in respect of human olfactory capabilities, tasteless in respect of human sense of taste, partially or fully transparent, or a combination thereof.

In some embodiments, the antimicrobial layer 100 may be biodegradable.

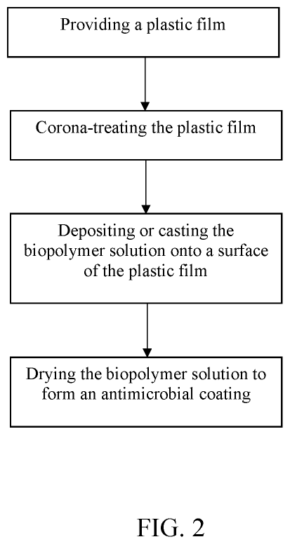

Referring to FIG. 2, embodiments may further relate to a method of forming the antimicrobial layer 100. The antimicrobial layer 100 may be formed by depositing or casting the biopolymer solution onto at least a portion of the plastic film 104, thereby laminating the plastic film 102 with an antimicrobial layer 102. The method may therefore include providing a plastic film 104. Providing the plastic film 102 may include conveying the plastic film, such as from a film roller.

The method may also include corona treating the plastic film 104 prior to casting the biopolymer solution onto the film. Corona treatment may refer to a surface treatment process used to enhance the adhesion properties of the film and may involve exposing a surface of the film to a high-voltage electrical discharge (corona discharge). This electrical discharge may ionize the air around the film, creating a plasma that interacts with the surface of the film.

The method also includes depositing or casting the biopolymer solution onto the surface of the film 104. Depositing the solution may include drip coating, spray coating, roll coating, slot die coating, extrusion coating, lamination, or any other suitable deposition technique. If necessary, the method may further include a step of levelling the solution once cast onto the plastic film 104 such that a consistent antimicrobial coating/layer 102 is ultimately formed on the film.

The method also includes drying the biopolymer solution such that an antimicrobial layer 102 is formed on the film. In some embodiments, drying the solution includes air drying the solution. In some embodiments, drying the solution includes heating the biopolymer solution/film. For example, an infrared heating apparatus may be used to heat the biopolymer solution/film. In some embodiments, an air stream, such as from a fan, may be used to expedite drying of the biopolymer solution. In one embodiment, an infrared heating apparatus may be used to obtain a film temperature of at least 50 °C and a fan be used to generate an air velocity of at least 12 m/s.

In some embodiments, the time required to dry the biopolymer solution may be less than 10 minutes, such as less than 8 minutes. It is contemplated that the combination of the heating temperature and the air velocity, together with the composition of the biopolymer solution, may enable drying to be completed within 10 minutes, such as within 8 minutes. The drying time may therefore be significantly reduced.

### Examples

A laminated antimicrobial film (LAF) was developed with a pullulan-based coating incorporating gelatin, glycerol, and lauric arginate (LAE), laminated onto a polyamide-polyethylene (PA-PE) substrate. To assess its commercial potential, the film was adapted for use with BOPE-EVOH (biaxially-oriented polypropylene-ethyl vinyl alcohol). Initial pilot-scale processing revealed sagging of the pullulan coating under gravity, which hindered drying and slowed production. To address these issues, eleven film-forming solutions (FFS) were designed using response surface methodology. These solutions aimed to reduce sagging, improve wetting on the packaging material, cut drying time, and retain antimicrobial properties. The FFS were tested for viscosity at 30 °C, 50 °C, and 70 °C, contact angle, and drying times at 50 °C, 60 °C, and 70 °C Antimicrobial efficacy against Escherichia coli O111, Salmonella Typhimurium, and Listeria monocytogenes J1-003 was evaluated through plate overlay assays. FFS with higher gelatin content showed better pathogen inhibition. Light microscopy analyses indicated the formation of gelatin-rich microparticles, suggesting phase separation between gelatin and pullulan. The optimized formulation contained 14.84% pullulan, 3.65% gelatin, and 74.0% water. Despite experimental values being higher and antimicrobial activity lower than predicted, the production of the film was improved using infrared heating at 50 °C and an air flow of 12 m/s. This combination reduced drying time to 7.22 minutes. Ultra-high pressure liquid chromatography with tandem mass spectrometry (UPLC-MS/MS) revealed that LAE release from the LAF followed a two-phase pattern: an initial burst followed by sustained release. This release profile is promising for enhancing the film's antimicrobial efficacy.

### Materials and Methods

Laminated antimicrobial film (LAF) components: Pullulan was obtained from High-Performance Product Engineering (HPPE), LLC (Columbus, GA). Glycerol≥99.7% was obtained from VWR Company (Radnor, PA, USA). A lauric arginate (LAE) solution, CytoGuard™ (20.02% LAE, 79.98% propylene glycol), was obtained from A&B Ingredients, Inc. (Fairfield, NJ, USA). Xanthan gum made from Xanthomonas campestris and gelatin from bovine skin were obtained from Sigma Aldrich (St. Louis, MO, USA). A corona-treated biaxially oriented polypropylene and ethyl vinyl alcohol (BOPE-EVOH) multilayer film was obtained from Transcontinental Inc. (Menasha, WI) for development of the pilot-scale manufacturing process. The composition of the BOPE-EVOH film is BOPE/adhesive/PE/PE-based tie//EVOH/PE-based tie/PE. The PE-based/Tie is made from the adherence of polyethylene (PE) to a low amount of maleic anhydride to crosslink the PE to the EVOH and to prevent delamination. A small quantity of Dow Retain 3000 (Dow, Midland, MI, USA) is added as a compatibilizer for the EVOH for recycling purposes. Corona-treatment of the material was used to enhance the adhesion of the pullulan containing to the BOPE-EVOH film.

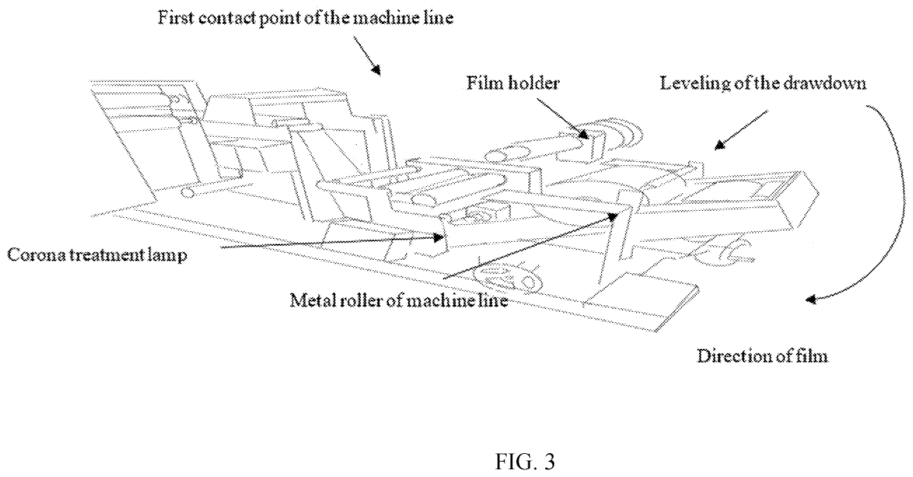

Development of the pilot-scale manufacturing process: Initially, a pilot scale manufacturing process was developed using a Kilian Film Line at the Behrend Plastics Engineering Technology Laboratory (FIG. 3). The corona-treated BOPE-EVOH film was positioned on the film roller to move clockwise toward the end of the machine. The film direction was designed to avoid areas where the wet coating may make contact within the machine, such as the additional rollers and the corona treater below the film line.

To control the thickness of the pullulan coating during manufacturing, a 1.70 cm×17.70 cm, 6-mil drawdown bar obtained by Gardco (Columbia, MD) was positioned onto the machine using a custom 3D-printed device to hold the bar in place.

The machine was set to a rate of 1 foot of film per minute to ensure adequate drying time before the first contact point on the machine line (6 feet). Using the gap clearance of the drawdown bar and velocity of the film roller, the shear rate of the coating during leveling was calculated to be 0.33 1/s using Equations (1) and (2).

$$Shear rarte ( 1 / s ) = \frac{Velocity ( m / s )}{height ( m )} \qquad ( 1 )$$

$$Where Velocity = \frac{Distance ( m )}{Time ( s )} \qquad ( 2 )$$

To develop the LAF using the pilot-scale manufacturing process, approximately 25 mL of the pullulan/biopolymer coating was applied using a graduated cylinder within the opening of the drawdown bar. Adequate saturation of the coating within the drawdown bar was performed to produce a consistent layer of coating with a width of 15.24 cm, onto the BOPE-EVOH film. To determine an optimal coating for pilot-scale processing, the shear rate calculated from the line was used to optimize the viscosity of the coating.

Experimental design of the coating formulation: A mixture design was created within design of experiments (DOE) using Minitab® statistical software (State College, PA) to determine an optimal coating for pilot-scale processing. Findings from previous research influenced the upper and lower limits of the pullulan, water content and gelatin proportions (Table 1). Unfortunately, an increased glycerol concentration resulted in an increase in film stickiness; therefore, glycerol (5%) and LAE (2.5%) proportions remained constant.

TABLE 1
Upper and lower limits of coating component proportions.

| Component | Lower Limit | Upper Limit |
|---|---|---|
| Pullulan | 12% | 15% |
| Gelatin | 2% | 5% |
| Water Content | 74% | 78% |

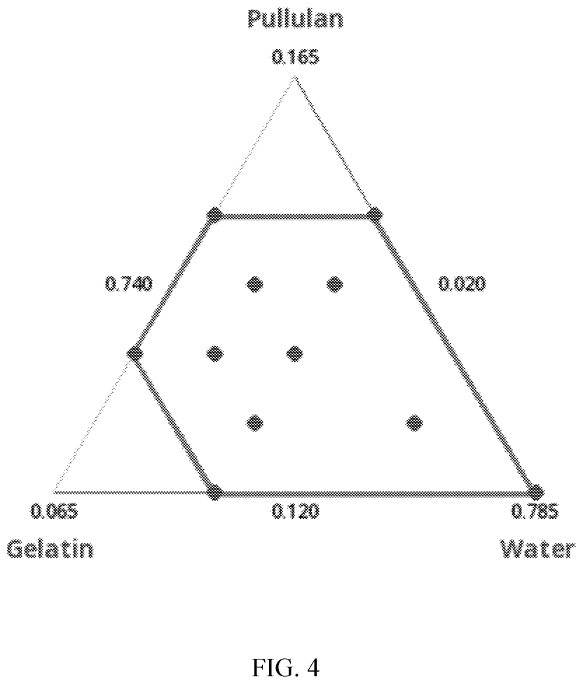

Using an extreme vertices factorial design, eleven film-forming solutions (FFS) were created within the design space of the simplex plot (FIG. 4).

The FFS were prepared by combining the specified amount of gelatin (w/v) and water content (v/v) and allowing the gelatin to swell for 60 minutes. Once fully hydrated, the mixture was placed on a hot plate and heated to 60 °C, then stirred until fully dissolved. Pullulan (w/v) was added in 10 g increments until the final volume was reached and stirred at 400 rpm for 60 minutes at 50 °C to prevent clumping. Once evenly dispersed a constant volume of glycerol was added at 5.0% (v/v) and stirred at 400 rpm for 60 minutes. Once all materials were added and dissolved, the temperature of the hot plate was increased to 100 °C and allowed to mix at 400 rpm for 2 hours to ensure even distribution. The mixtures were then autoclaved for 15 min at 121 °C and cooled to 55 °C in a water bath. Once cooled, lauric arginate in the form of Cytoguard™ was added at 2.5% (v/v) to achieve a final concentration of 0.5% LAE. The solutions were then transferred to 15 mL conical tubes and stored at room temperature for future use.

Effect of pullulan, gelatin, and water content on the viscosity at 33 1/s: During the addition of the pullulan layer to the BPOE-EVOH, the pullulan coating dripped as the film moved along the manufacturing line. To optimize the pullulan coating and reduce dripping during manufacture, the viscosities of the FFS were modified using a dynamic shear rheometer (Discovery, HR-3 TA Instruments) with a parallel plate geometry of 45 mm and gap clearance of 5910.76 μm to determine the apparent viscosity of the film-forming solutions at 30 °C, 50 °C, and 70 °C within a shear range of 1-100 1/s. The viscosity values were obtained at the calculated shear rate of the pilot-scale manufacturing process; 33 1/s, was used within the mixture design to determine the effect of the pullulan, gelatin, and water proportions on the coating viscosity. The experimental data were fitted to the power-law model according to Equation (3) to characterize the rheological behavior of the FFS.

τ=kγⁿ (3)

Within the model, the consistency coefficient (K) and flow behavior index (n) are used to determine the flow behavior. When n<1, the material is pseudoplastic or shear thinning; when n=1, the material is Newtonian; and if n>1, the material is dilatant or shear thickening. The K value relates to the viscosity of Newtonian fluids. Both coefficients can be used to determine the viscosity of a material at a given shear rate (γ). The data were analyzed using a two replicate of the formulations; the power law was fitted in Excel® (Microsoft, Redmond, WA).

Effect of pullulan, gelatin, and water content on contact angle: Static contact angle goniometry (Ramé-Hart model 295) was used to determine the contact angle of the FFS onto the BOPE-EVOH film. The relationship between a static contact angle and surface energy force can be defined by Young's equation:

Y_{SV}=Y_{SL}+Y_{LV} cos θ (4)

Y_{SV}=solid-vapor interaction, Y_{SL}=solid-liquid interaction, and Y_{LV}=liquid-vapor interaction.

BOPE-EVOH films (2.54 cm×9.14 cm) were positioned onto the machinery stage using film clamps. To perform the measurements, drops were briefly and carefully lowered onto the films to prevent the effects of the falling drop on the pinning diameter. As the formulations were gelled at room temperature, the coating solutions were submerged within a 50 °C water bath and allowed to come up to 50 °C±0.50 °C before sampling. The drop volume was constant for each measurement, with each drop being between 3 and 4 μL. Approximately 60 seconds after the drop contacted the film, the dispensing needle was removed, and the sampling began. The measurements were obtained by taking an average of 10 images over 10 seconds. Ramé-Hart DropIMG™ software (Ledgewood, NJ) was used to perform the image processing and calculate the contact angles. The analyses were performed at standard atmospheric pressure and room temperature (25 °C). All measurements were performed in triplicate. Averages and standard deviations were calculated in Excel® (Microsoft, Redmond, WA) and used within the mixture analysis.

Effect of pullulan, gelatin, and water content on the drying time at 50 °C, 60 °C, and 70 °C: The production of the LAF is greatly hindered by the time it takes the pullulan coating to dry. To determine the effect the coating components (pullulan, gelatin, and water content) have on the drying time of the coating, the drying time was evaluated at 50 °C, 60 °C, and 70 °C. Using a moisture content analyzer (Sartorius; Göttingen, Germany), approximately 1.00±0.02 g of each FFS was deposited into a tared aluminum pan (Sartorius) and dried at the specified temperatures. The weight was recorded every two minutes until a constant weight was reached for at least four measurements. The time increment of the first value of the final weight was used to indicate the time of drying time of the FFS. The developed LAFs were placed in a desiccator overnight to be used in subsequent plate overlay analyses for antimicrobial activity. All measurements were performed in duplicate. Averages and standard deviations were calculated in Excel® (Microsoft; Redmond, WA) and used within the mixture analysis.

Effect of drying temperature on the antimicrobial activity of the LAF: To determine if the drying temperature (50 °C, 60 °C, and 70 °C) impacted the antimicrobial activity of the developed LAFs, plate overlay assays using Shiga toxin-producing Escherichia coli O111 (E. coli O111), Listeria monocytogenes J1-003 (L. monocytogenes J1-003) and Salmonella Typhimurium (S. Typhimurium) were conducted using a method adapted from Cutter and Siragusa (65). The bacterial strains were confirmed molecularly through polymerase chain reaction (PCR) using sigB genes for Listeria spp., Stx 1 and 2 genes for Shiga-toxin producing E. coli strains and invA genes for Salmonella Typhimurium. The prepared LAFs developed within the drying analysis described above were used to evaluate the effect of drying temperature on the antimicrobial activity of the FFS. LAFs of the FFS dried at room temperature (25 °C) under a biological safety hood at 40% relative humidity were used as a point of reference in the analysis.

The developed LAFs were aseptically punched into 6 mm disks using a sterile hole-puncher. Using the freezer stocks obtained from the previously described plate overlay assay, a loopful of the halfway-thawed freezer stock was streaked onto a sterile tryptic soy agar (TSA) plate and incubated at 37 °C for 24 hours. A bacterial colony was inoculated into 9 mL of sterile tryptic soy broth (TSB) and incubated at 37 °C for 24 hours. Approximately 1 mL of the inoculated TSB was transferred into 9 mL of 2.5% TSA molten agar (50 °C). The inoculated 2.5% molten agar was vortexed and poured atop a sterile TSA plate to produce a bacterial lawn containing approximately 8 log 10 CFU of E. coli O111, L. monocytogenes J1-003, and S. Typhimurium. Once solidified, the 6 mm disks of the LAF were placed aseptically onto the bacterial lawn using sterile tweezers. The TSA plates were inverted and incubated at 37 °C for 24 hours. Zones of inhibition or clearing around the diameter of the disks were calculated using calipers (General UltraTech, NY). All measurements were performed in triplicate. Bacterial enumeration by the spread plate method onto sterile TSA plates was performed for each bacterium to determine the concentration of E. coli O111, L. monocytogenes J1-003 and S. Typhimurium used in the plate overlay assays.

Light microscopy of the LAF: LAFs were stained to evaluate the phase separation of gelatin and pullulan within the developed LAFs. The films were stained using a 2.5% glutaraldehyde solution for 60 seconds, then rinsed with distilled water. Immediately after rinsing, approximately 1 mL of 0.5% fast green solution was used to stain the protein within the film. The staining solution remained on the film 60 seconds before rinsing with distilled water. The LAFs were dried overnight under a biological safety hood at 40% relative humidity and analyzed by light microscopy (Hitech Instruments, PA) at magnifications of 100× and 50×.

Determining the optimum formulation of the LAF: Determining the target viscosity—A preliminary experiment was performed to determine a target viscosity that produced minimal dripping when exposed to gravitational stresses. The preliminary experiment mimicked the gravitational stresses imposed on the coating while moving throughout the manufacturing line. A 10 cm×7.5 cm piece of BOPE-EVOH was positioned onto a 11.5 cm×7.5 cm steel-plated cylindrical cup to quantify the amount of formulation drip off. Approximately 1 mL of the coating was deposited onto the film and inverted above a weigh boat, then weighed. The formulations producing the least amount of drip (1, 9, and 11) were used to determine the apparent viscosity at 30 °C and 70 °C within a shear rate of 1/s to 100/s with a parallel plate geometry of 50 mm and gap clearance of 510.419 μm using a rheometer (Atlas, TA Instruments). The identified viscosities were used to determine the target viscosity of the optimal formulation for scale up.

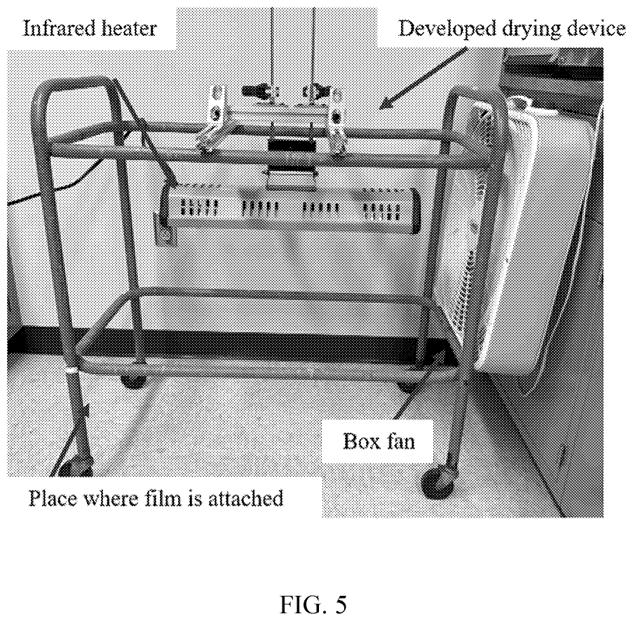

Development of the optimal LAF-Due to inadequate space, a drying chamber failed to be developed within the pilot-scale film line. Therefore, a drying chamber was designed to produce the optimized LAF at the temperature found within experimentation. To evaluate the physical and mechanical properties of the optimal coating, three LAFs were developed using the conditions determined in the procedures above. The FFS were heated to 50 °C, dispensed, and spread onto the corona treated BOPE-EVOH film using a 6-mil drawdown bar. The film was then carefully placed on the drying apparatus (FIG. 5). The heated infrared source was used to obtain a film temperature of 50 °C and box fan was used to generate an air velocity of 12 m/s. The drying apparatus was developed by fixing an infrared dryer (H1-1500-OTR Tradesman, Franklin GA) to 1.5 cm×52.07 cm, 80/20 building material. Two steel 20.48 cm polls were used to allow the drying device to move up and down to increase or decrease the proximity of the drying apparatus to the film. Preliminary analyses found a distance of 25.5 cm from the LAF was needed to adequately dry the film without degradation to the film (data not shown). To expedite drying time, the addition of air flow was added using a box fan (Lasko, USA) at 12 m/s. The temperature and velocity of the air flow were monitored using a hot wire anemometer (VWR, Radnor, PA). Since the drying apparatus was developed at the Food Science department, the drawdown bar was used to coat the BOPE-EVOH film before drying manually. Three independent replicates of each film were developed.

Characterization of the optimized LAF: The thickness (T) of each film strip (μm) was measured with a micrometer (iGaging, USA Precision Engineering) at 5 random points for each sample. Film transparency (%) was determined using a spectrophotometer (Thermo Scientific™ GENESYS™ 10S UV-Vis Spectrophotometer). The percent transmittance at 600 nm (Tm₆₀₀) was measured for each sample and the results were used for calculating the film transparency according to the Equation (5) below. For each film type, 3 replicates were measured.

$$Transparency = \frac{Log ( Tm 600 )}{T} \qquad ( 5 )$$

LAFs weighing 1.00±0.02 g were placed in a moisture content analyzer (Sartorius, Germany) at 105 °C and dried to a constant weight. Using the weight loss obtained, the moisture content was calculated according to Equation (6). The swelling of the LAFs was determined to evaluate the stability of the film at higher humidity. Pieces of the LAF cut to 60×15 mm disks of film were placed in a desiccator containing 1000 ml of DI water to attain 100% relative humidity using for 5 days. At 24 intervals, (24, 48, 72, 120, and 190 hours), the samples were weighed and placed immediately back into the desiccator. Using the initial and averaged final obtained weight at equilibration (72 and 190 hours), the swelling was calculated as followed:

$$Mc = \frac{MI - MF}{MF} \times 100 \qquad ( 6 )$$

$$Sw = \frac{Ws - Wc}{Wc} \times 100 \qquad ( 7 )$$

Where M_{I} is the initial weight of the coating M_{F} is the final weight of the film. W_{S} is the weight (g) of the swollen sample after immersion and W_{C} is the weight (g) of the initial sample.

To determine the release kinetics of LAE from the LAF, freshly prepared LAFs were cut to 1 cm×5 cm and placed within 50 mL of food simulant A, 10% ethanol, and stirred at 200 rpm at 25 °C A 1 mL was taken at 15 s, 30 s, 1 min, 3 min, 6 min, 9 min, 12 min, 15 min, 45 min, and 60 minutes. After sampling, the collected samples were vortexed at 3000 g (VWR, Radnor, PA), diluted within a calibration curve range, and quantified using the developed ultra performance liquid chromatography tandem mass spectrometry (UPLC-MS/MS) method. Three individual replicates were performed. Averages and relative standard deviations were performed in Excel® (Microsoft; Redmond, WA).

The cost of the developed LAF was calculated by obtaining the wholesale cost of the raw materials of gelatin, glycerol and non-organic pullulan. The low and high values reflect the lowest and highest cost associated with each wholesale product. The low and high prices of the CytoGuard™ solution (LAE) and BOPE-EVOH were provided by A&B Ingredients, Inc. (Fairfield, NJ) and Transcontinental Inc. (Menasha, WI), representing the fluctuating market value of LAE and the unprinted (low) and printed (high) value of the BOPE packaging material. The cost of organic pullulan (high) was provided by High-Performance Product Engineering (HPPE), LLC (Columbus, GA). To determine the cost of the optimal LAF, the price of each component was converted to grams to determine the cost of the optimal pullulan coating (g/mL). The cost of the BOPE-EVOH packaging film was provided in pounds; therefore, the weight of approximately 15.24×20.48 cm, (3.21 g) was used to determine the cost of film per square (m⁻²). The cost of the BOPE-EVOH was calculated and combined with the calculated cost of the pullulan coating to determine the cost of LAF per m⁻² and kg of product.

Statistical Analysis: All data from the individual experiments were manually recorded in Excel® (Microsoft; Redmond, WA). The mixture design was developed using Minitab® Statistical Software. Regression for mixture and analysis of variance (ANOVA) was used in Minitab® to evaluate the responses of the optimization experiments. The selection of the optimal coating used was performed in Minitab® utilizing the D-optimal approach, within the mixture design. One-way ANOVA followed by a Tukey post-hoc test to identify significant (P<0.05) differences was performed within the thickness, transparency, swelling, and moisture content analyses using R studio 2.2 within Biorendr (Toronto, Ontario).

### Results and Discussion

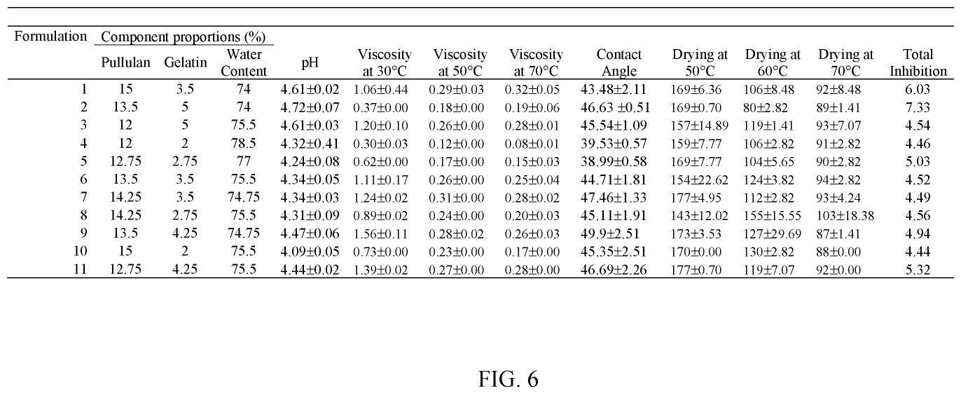

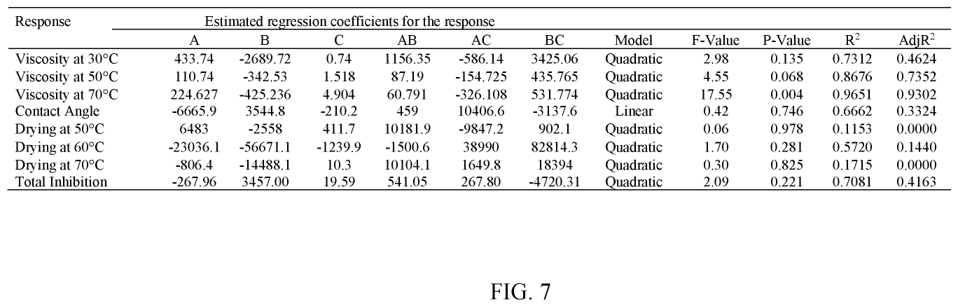

The response data of the experimental runs are shown in FIG. 6. The regression coefficients and ANOVA results obtained from these experiments demonstrate how the components, gelatin, pullulan, and water content, in the form of the regression coefficients, influences the generation of the predictive models (FIG. 7). The contour plots associated with each response will be discussed separately.

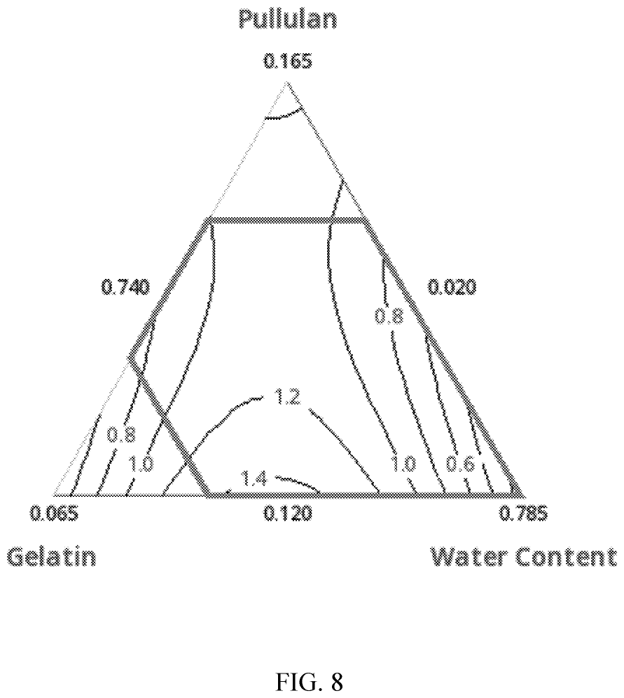

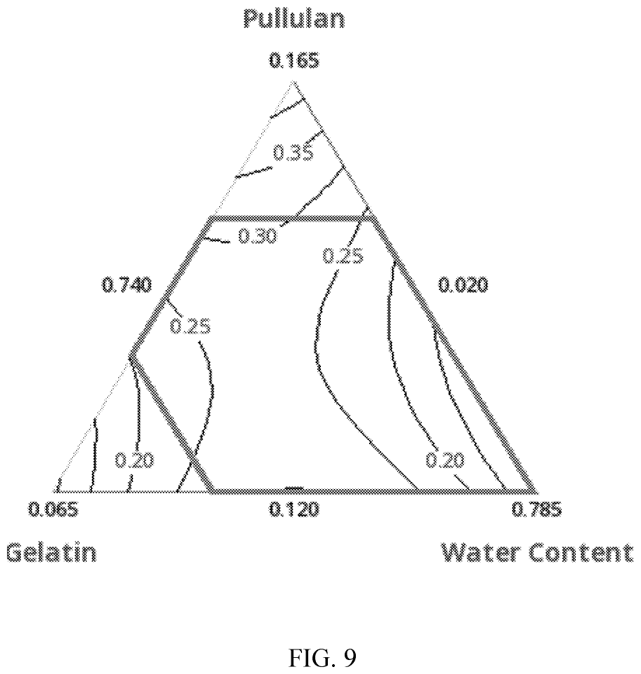

Effect of pullulan, gelatin, and water content on the viscosity at 33 1/s at 50 °C, 60 °C, and 70 °C: At 30 °C the apparent viscosity of the FFS decreases as the content of gelatin content in the FFS approach 6.5%, respectively (FIG. 8). This observance is referred to as “slip” and occurs within highly concentrated emulsions or solutions. Biopolymer solutions containing high concentrations of high molecular weight polymers, such as pullulan and gelatin, are prone to the occurrence of slip due to static, viscoelastic, or gravitational forces. However, at the temperatures 50 °C and 70 °C, the FFS containing increased water content, demonstrates lower apparent viscosities when compared to those with increased polymer concentrations (FIGS. 8 and 9).

This result is expected since the water within the formulation acts both as a solvent and plasticizer, reducing the viscosity of the coating. In addition, in solutions with increased solvent or water content, the individual molecules of the polymers move freely and have a small impact on the viscosity of the solution. Within the coating, water molecules can form hydrogen bonds with polar molecules in both pullulan and gelatin. In gelatin, scientists found water molecules to bridge the —CO and —OH groups of a single hydroxyproline residue or the —OH groups within two hydroxyproline residues. Similarly, when combined with pullulan, water molecules can form hydrogen bonds through the —OH groups associated along the polymer chain.

The binding of water molecules increases the distance between polymer chain segments, thereby decreasing the segmental motion's activation energy. This finding, in turn, increases the mobility of the polymer chains, allowing the polymer to move freely. Therefore, water works effectively as a plasticizer by weakening the existing hydrogen bonds and dipole-dipole intra- and inter-macromolecular interactions of the polymers. These interactions result in lowering the coating solution's viscosity.

The solutions were allowed to cool to room temperature before evaluation to determine the viscosity within the specified temperature range. Below the melting point of 40 °C, gelatin solutions exist as gels. The gelation of gelatin results in the cross-linking of polymer chains that form a 3-dimensional (3D) network that entraps water to form a rigid structure resistant to flow. The formation of the 3D structure or junction zones returns the gelatin structure from the random coils found in the solution to collagen-like helices. The point at which the change in conformation occurs is commonly referred to as the gelling point. The gelling point of bovine gelatin is between 26 °C and 37 °C respectively. However, gelation of gelatin is a physical occurrence through van der Walls interactions and is, therefore, thermoreversible. Above the melting point, the structure of gelatin can return from helices to random coils, allowing the structure to conform from a gel to a solution again.

At 30 °C, the apparent viscosity of the solution increased as gelatin concentration increased. The gelation of gelatin is likely a result of the increased viscosity observed at low temperatures. This behavior has been followed by other researchers, who found that solutions containing increased gelatin concentrations exhibited higher viscosity at temperatures below 35 °C than those containing increased pullulan concentrations. In contrast, at temperatures above the melting point of gelatin and increased polymer concentration, the pullulan-rich region of the solutions demonstrated higher viscosity. These results can be observed (FIG. 9), where the coating solutions containing increased pullulan content demonstrated higher viscosity.

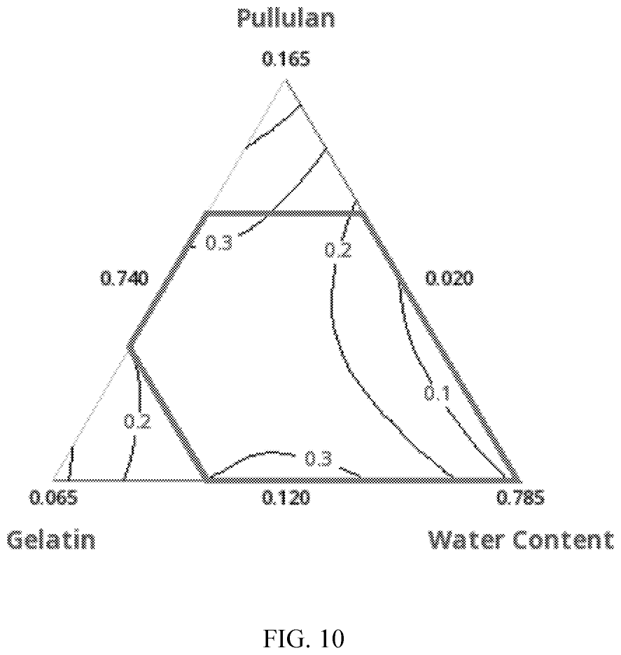

The viscosity of gelatin solutions is primarily due to the quantity of α-helices in the solution. In solutions above the melting point, the α-helices are conformed to random coils, resulting in decreased viscosity. This drop in viscosity can be observed (FIG. 10), since the FFS demonstrating increased gelatin concentration decreases in viscosity at 70 °C Like gelatin, pullulan coatings demonstrate increased viscosity due to its chemical structure and molecular weight. When pullulan is in solution, there are also random coils, where the physical entanglement of the coils and the water binding capacity of the polymer chains cause an increase in viscosity. Pullulan, however, does not gel. Therefore, solutions containing pullulan and gelatin typically demonstrate better thermal stability than just gelatin solutions across temperature gradients.

When fitting the experimental data to the power law model, the power law index, N, was found to be less than 1, indicating shear thinning behavior for all formulations across the temperature range, except formulation 4 at 70 °C (see FIG. 7). FFS 4 contains the highest water content, which likely explains the formulation displaying Newtonian behavior at high temperatures. Shear-thinning rheological behavior is ideal during manufacturing due to the ability to thin during high shear activities such as leveling. In contrast, at low shear rates, shear thinning solutions demonstrate increased viscosity, reducing the prevalence of sagging or slumping.

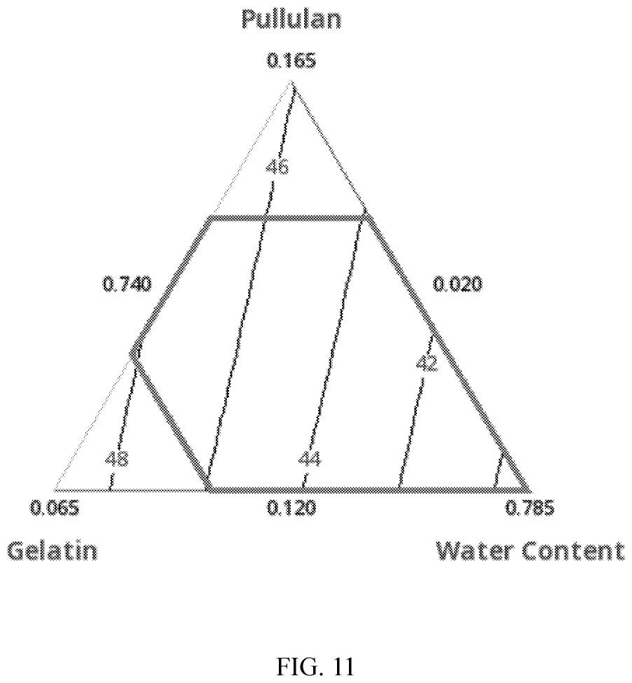

The effect of coating component concentration on the contact angle of the coating: As the concentration of pullulan and gelatin in the coating increased, the contact angle too increased (FIG. 11). The results demonstrate that water content plays a significant role in reducing the contact angle of the solution when applied to the corona-treated BOPE-EVOH film. In solution, gelatin and pullulan are thermodynamically incompatible. Previous work found gelatin in concentrations between 2 and 4% to separate into phases when in solution with linear polysaccharides, such as pullulan. The phase separation of the polymer-rich phases within the solution become solvents for other molecules, such as LAE, to partition in.

LAE within solution acts as a wetting agent, lowering the interfacial surface tension of the solution and, therefore, decreasing the contact angle. However, LAE is cationic and interacts with both positively and negatively charged components within solutions. Since pullulan is nonionic and therefore does not interact or form complexes with LAE, it is likely the LAE in solution exhibits an affinity to the gelatin phase of the solution.

Gelatin contains amino acid side chains such as glycine, proline and hydroxyproline consisting of carboxylic acid and primary amine groups. When gelatin solutions are below or above their isoelectric points (4.5), the functional groups are protonated and deprotonated, lending to various interactions between gelatin and ionic molecules. The pH within the formulation is between 4 and 5, where gelatin exists as a polyampholyte containing side groups with both negative and positive charges. Gelatin has been found to demonstrate electrostatic and hydrophobic interactions with ionic polysaccharides, such as chitosan, cellulose, and carrageenan. Like gelatin, LAE has demonstrated interactions with both anionic and cationic polymers through electrostatic and hydrophobic interactions. In solution with cationic polysaccharides, such as chitosan, electrostatic repulsion has been found to occur between the two components. Due to the repulsion observed between both components, the researcher observed a decline in the critical micelle concentration (CMC) of LAE.

However, in solution with both positive and negative charges, the electrostatic repulsion of LAE likely increases the surfactants affinity to the anionic portion of gelatin. Conversely, the complexes formed between LAE and gelatin would be due to attractive forces between the anionic and cationic groups in solution. Due to this reaction, the hydrophobic tail of gelatin would remain in the predominant portion in the solution, increasing hydrophobicity of the solution with increased gelatin content. It has been found that increasing concentrations of gelatin increased the contact angle of the solution due to interactions between both components and thus, developing a hydrophobic complex. Alternatively, in a dilute solution with increased water content and decreased gelatin concentration, less polymer interacts with LAE. Therefore, more LAE is left in the solution to interact with the BOPE-EVOH.

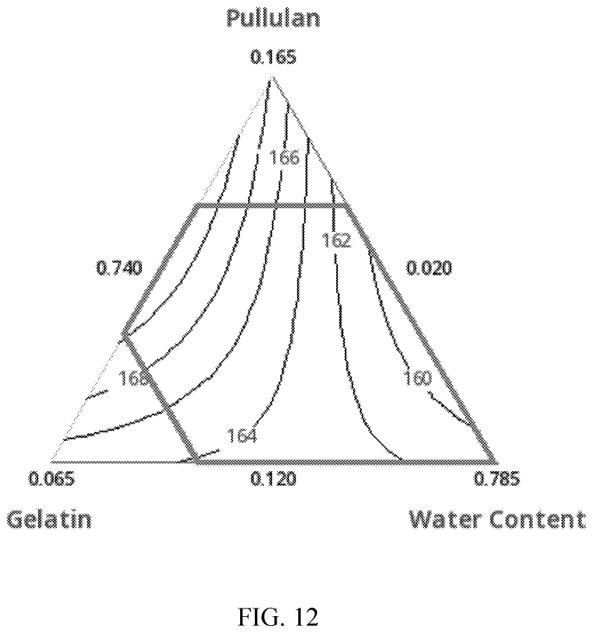

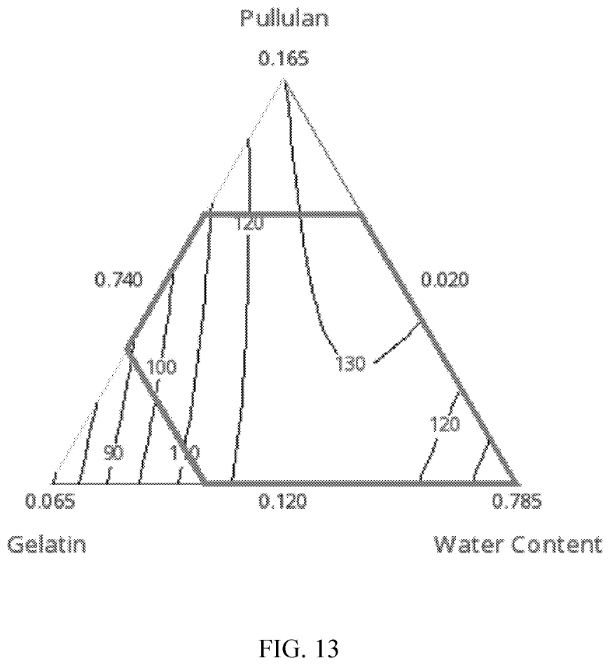

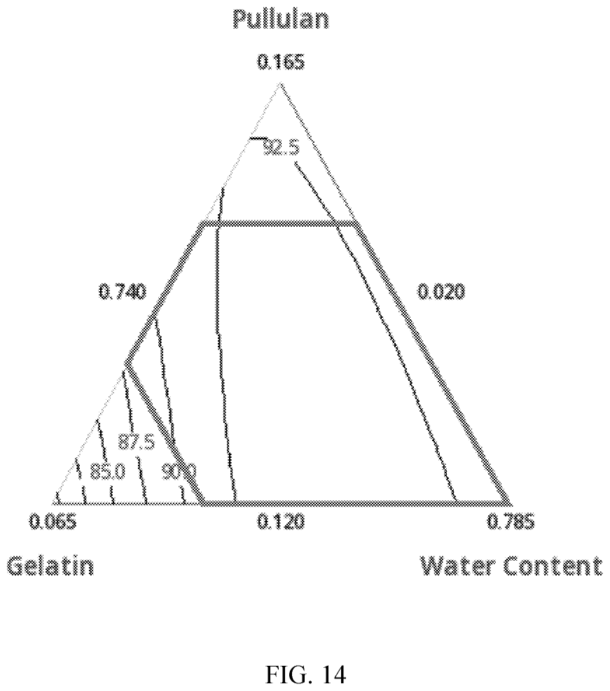

The effect of coating component concentrations on the drying time of the coating at 50 °C, 60 °C, and 70 °C: At 50 °C, the drying time decreased as water content increased (FIG. 12). Conversely, at 60 °C and 70 °C the opposite occurred where the drying time increased, as the proportion of water content increased (FIGS. 13 and 14). This finding may explain the occurrence of casehardening of the coating during drying. Drying can be separated into two stages, where the initial stage, constant drying occurs through evaporation. During this stage, the water removed is unbound water and lost at a constant rate. When all the free water evaporates, a falling rate occurs, where the dehydration rate decreases. At this stage, complex interactions occur between the film surface and the moisture or heat diffusion within the internal layer of the film.

These interactions determine the remaining drying rate of the film, in addition to any deformations and textural irregularities. During drying, phase transition occurs as the coatings goes from liquid to solid. As drying progresses, the polymers reach their glass transition point, where the material goes from a soft and rubbery state to hard and glassy. The glass transition point is a second order reaction and is a function of temperature and moisture content. During the change from the rubbery to glassy state, higher stresses develop within the material that can result in deviations from the ideal shrinkage behavior found in drying. As the solution dries, shrinkage of the material occurs, and in an ideal case, the mechanical properties are low enough to develop stresses to counter the hygroscopic stress due to capillary pressure. This finding results in the subsequent shrinkage to be directly proportional to moisture loss. However, when non-ideal situations occur as a result of increased heat or faster drying times, changes in textural attributes and case-hardening can follow.

Case-hardening is a phenomenon that results in the outer surface of the material drying faster than the core of the surface. During case-hardening, the outer surface enters the hard and glossy state prior to the internal core of the film, resulting in the increase in drying time of the coating, as well as the occurrence of cracks and textural defects. Case-hardening occurs due to increased drying temperature, air velocity and lower relative humidity within the drying chamber.

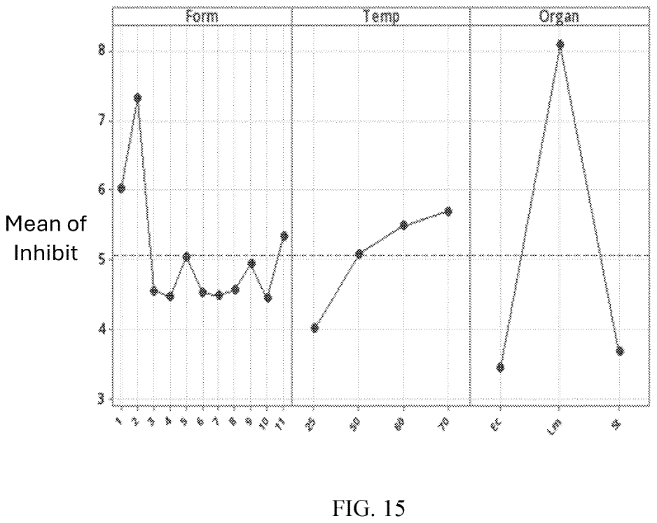

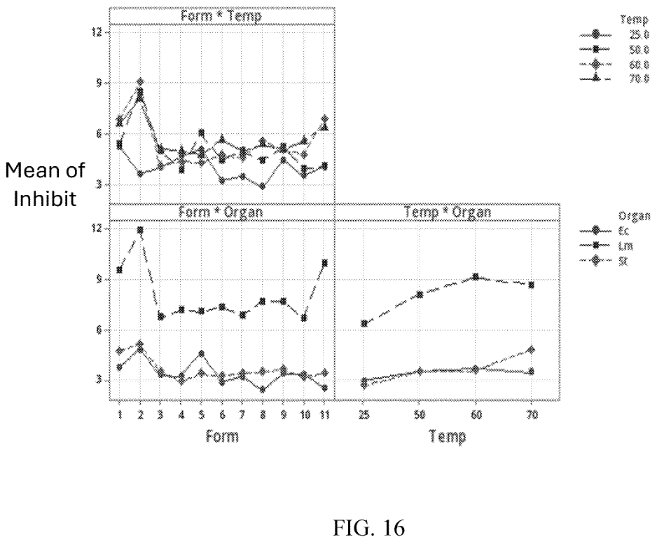

Effect of drying temperature on the antimicrobial activity of the LAF: The main effects plot represents the response mean of each of the parameters of the optimization. When the plot line is parallel to the x-axis, no response influences the output variable. The main effects plot demonstrated the interactions between formulation, organism type, and drying temperature the microbial inhibition of the LAFs (FIG. 15). The interaction plot demonstrates the relationship between one of the parameter responses and the output variable. The interaction plot confirms the interaction between formulation, organism type, and drying temperature on the microbial inhibition against the foodborne organisms (FIG. 16). Three observations between the coating components in the formulation and the inhibition against the pathogens were observed. The first observation revealed increased inhibition against L. monocytogenes J1-003 when compared to E. coli O111, and S. Typhimurium.

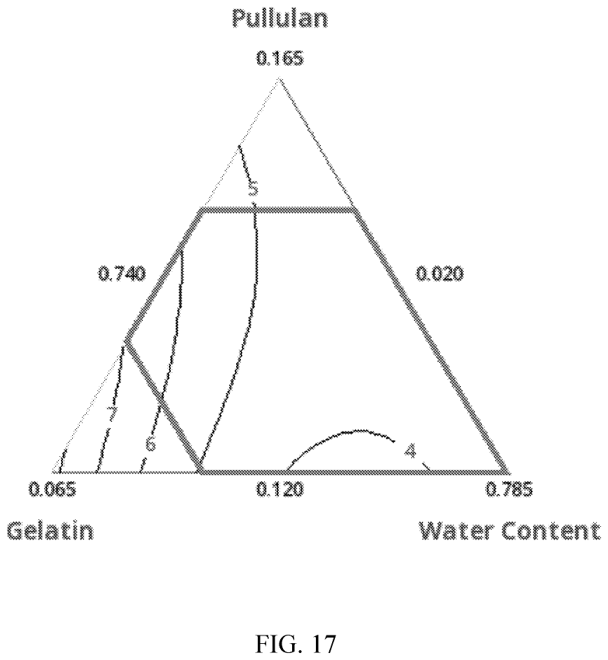

This result is expected since LAE demonstrates higher efficacy towards Gram-positive bacteria. The second observation revealed the FFS containing the least amount of water content demonstrated the highest inhibition against L. monocytogenes J1-003, E. coli O111, and S. Typhimurium (FIG. 17). Conversely, the formulations containing increased gelatin demonstrated higher inhibition. The results coincide with the findings observed within the contact angle analysis of the pullulan coatings, where formulations containing increased gelatin content resulted in FFS with significantly higher degrees of contact angle. As previously mentioned, it was hypothesized, the LAE within the coating partitioned within the rich gelatin phase of the coating solution due to interactions between the two components.

Again, gelatin and pullulan are thermodynamically incompatible and are therefore, known to separate into two phases. Upon phase separation, the formation of microstructures of one polymer can occur within a continuous phase of the other. The formation of microparticles is likely due to the decline in temperature below the gelation temperature of gelatin as well as the shift in molecular ordering occurring as the gelatin helices return from random coils to double/triple helices.

Determinization the optimum formulation and characterization of the developed LAF: The formulations identified within the preliminary analysis were FFS 9, 11, and 1, respectively. Using the selected coatings, the shear rate was measured 1-100 1/s at 30 °C to quantify the viscosity of the solutions observed to identify a target viscosity range for optimization. The viscosity range of each formulation was recorded to locate the optimum viscosity of the coating during processing. The lowest, median, and highest viscosity values obtained were 0.27 pa·s, 0.37 pa·s and 0.81 pa·s, respectively. The temperature chosen for optimization of the viscosity of the coating was 50 °C, since there were more formulations found within the target viscosity range for the optimized coating. Since drying temperatures higher than 50 °C resulted in case hardening, the drying temperature of 50 °C was selected to reduce possible defects of the physical properties of the developed LAF.

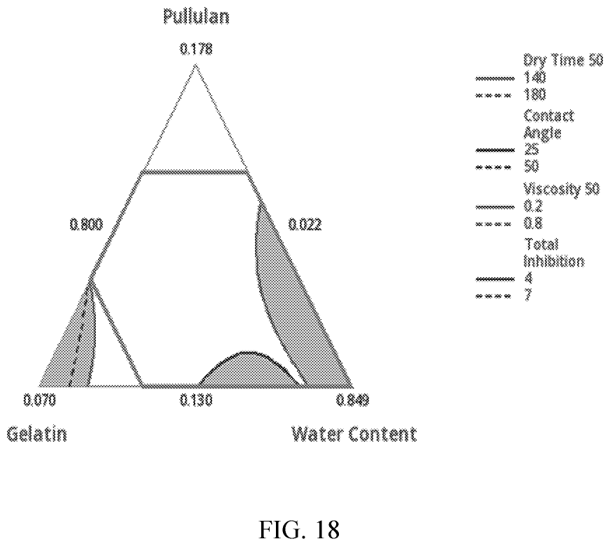

To determine the optimal coating formulation, the goal settings were adjusted to minimize the contact angle and drying time of the formulations. Conversely, the setting for inhibition against all three foodborne pathogens was set to maximize. Within the design space of the contour plot, the responses failed to overlap to produce an optimal coating formulation (FIG. 18). This finding was due to the influence of both gelatin and water content proportions found within the experimental responses. Increased water content resulted in decreased contact angle and drying time at 50 °C, favoring the initial goal of minimization. However, increased water content decreased the viscosity of the coating solution outside of the target values as well as declined microbial inhibition against the pathogens. Similar results were observed by the gelatin component of the coating, since the component negatively impacted the contact angle and drying time of the formulation but demonstrated increased inhibition against the pathogens. To obtain an optimal coating, the weight of importance of each response was adjusted (Table 2). The total inhibition of the developed LAF against each foodborne pathogen was set to the highest weight of 2.0, respectively.

The response was prioritized as the inhibition of foodborne pathogens is the ultimate function of the LAF and should not decline due to scale-up processing. The contact angle and viscosity were evenly set to 1.0 as the two responses greatly impact the lamination of the coating onto the BOPE-EVOH film. Although, the drying time of the coating greatly impacts the production speed and yield during processing, the weight was set to the lowest setting of 0.5 to minimize negative attributes of the developed LAF.

TABLE 2
Optimization parameters of the mixture design to determine the optimal formulation.

| Response | Goal | Lower | Target | Upper | Weight | Component | Proportion |
|---|---|---|---|---|---|---|---|
| Contact Angle | Target | 25.0 | 45.0 | 50.0 | 1.0 | Pullulan | 14.84% |
| Viscosity | Target | 0.2 | 0.4 | 0.8 | 1.0 | Gelatin | 3.65% |
| Total inhibition | Maximum | 4.0 | 7.0 | 7.0 | 2.0 | Water content | 74.00% |
| Drying Time | Minimum | 140.0 | 140.0 | 180.0 | 0.5 | Composite | 0.4834 |
| | | | | | | Desirability | |

Using the weights added, an optimal formulation was found containing pullulan at 14.84%, gelatin at 3.65% and water content at 74.0%, respectively (Table 2). The desirability of optimized coating was 0.4834, with predicted values of having a contact angle of 47.23°, viscosity of 0.305 pa·s, inhibition of 5.76 mm and drying time of 168.26 minutes, respectively. The predicted results were validated with experimental responses of the optimal coating, where percentage error was calculated. The contact angle, viscosity, and drying time demonstrated higher values than the predicted response with percent error of −1.54, −11.84, and 15.87%, respectively. However, the average inhibition against the pathogens demonstrated reduced inhibition when compared to the predicted response and demonstrated a percent error of −54.0%, respectively. When optimizing the formulation of antimicrobial active films, desirability function has been used to develop films with maximized antimicrobial activity and mechanical properties and minimized water vapor and oxygen permeability. Others have found their optimum formulation consisted of a global desirability of 0.7264 and was developed using the lowest amount of the antimicrobial agent nisin, to produce films with enhanced barrier and mechanical properties.

Development of the scaled-up LAF: Using the optimal coating, the drying of the coating was scaled up to evaluate the physical and mechanical properties of the LAF. An infrared heater was placed approximately 10 inches above the film to facilitate drying at 50 °C A box fan was used to introduce air flow at a velocity of 12 m/s. Using the developed drying conditions, three films were developed to evaluate the properties of the optimal film within a laboratory setting: 0% LAE, 0% LAE with 7.5% glycerol, and 0.5% LAE (Table 3). The incorporation of LAE in the coating solution reduced the pH of the coating, since the coating containing 0.5% LAE exhibited a pH of 4.36, as compared to the 0% LAE, 6.25 and 0% LAE 7.5% Gly, 5.87, respectively. This result is expected since LAE is a cationic surfactant with a pKA of about 10 to 11 and an isoelectric point above a pH of 12.

TABLE 3
Development of the optimal coating laminated antimicrobial films.

| Optimal | | | Water | | (0.5% | | Drying |
|---|---|---|---|---|---|---|---|
| Coating | Pullulan | Gelatin | Content | Glycerol | LAE)* | pH | time (min) |
| 0% LAE | 15.20% | 3.74% | 74.00% | 5.12% | 0.00% | 6.25 ± 0.04 | 11.43 ± 0.83 |
| 0% LAE | | | | | | 5.87 ± 0.01 | 10.68 ± 1.45 |
| 7.5% Gly | 14.85% | 3.65% | 74.00% | 7.50% | 0.00% | | |
| 0.5% LAE | 14.85% | 3.65% | 74.00% | 5.00% | 2.50% | 4.36 ± 0.03 | 7.22 ± 0.92 |

The data are represented as averages and standard deviations of three individual replicates.

The developed optimized films containing 0% LAE demonstrated a drying time of 11.43 and 10.68 minutes, whereas the optimal formulation containing 0.5% LAE exhibited a drying time of 7.22 minutes, respectively. The drying time decreased considerably within the scaled-up setting, using infrared radiation with the addition of air flow.

The drying apparatus was coupled with the pilot-scale manufacturing process to evaluate the optimal pullulan-coating. Minimal drippage was noticed when evaluating the coating on the machine at rate of one foot per minute. Similar results were observed as the rate increased to seven feet per minute and above. The pullulan coating was noticeably thicker than those performed under laboratory conditions. Removing the BOPE-EVOH film from the film line without impacting the wet pullulan coating layered was difficult; therefore, only small, non-impacted segments were used with the previously described drying parameters. The drying time of the optimal coating using the pilot scale manufacturing process (>10 minutes) was similar to the films produced under laboratory conditions. Samples were taken from three replicates produced under laboratory conditions and used within the following analyses: thickness, transparency, moisture content, and swelling.

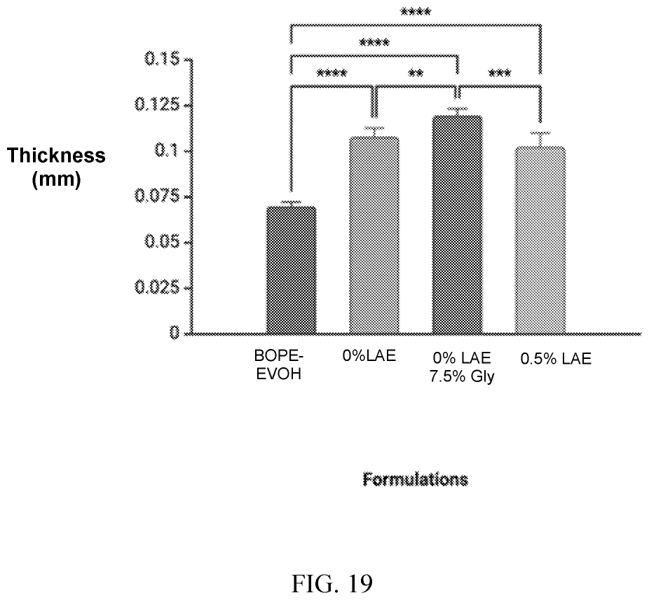

Thickness and Transparency: The thickness of the BOPE-EVOH, 0% LAE, 0% LAE 7.5% Gly, and 0.5% LAE films were 0.07, 0.108, 0.1196, and 0.103 mm, respectively (FIG. 19). All three LAFs demonstrated significantly (P<0.05) thicker films when compared to the BOPE-EVOH film.

Both LAFs containing 0.5% LAE, and 0% LAE produced significantly thinner films compared to the LAF containing 0% LAE and 7.5% glycerol.

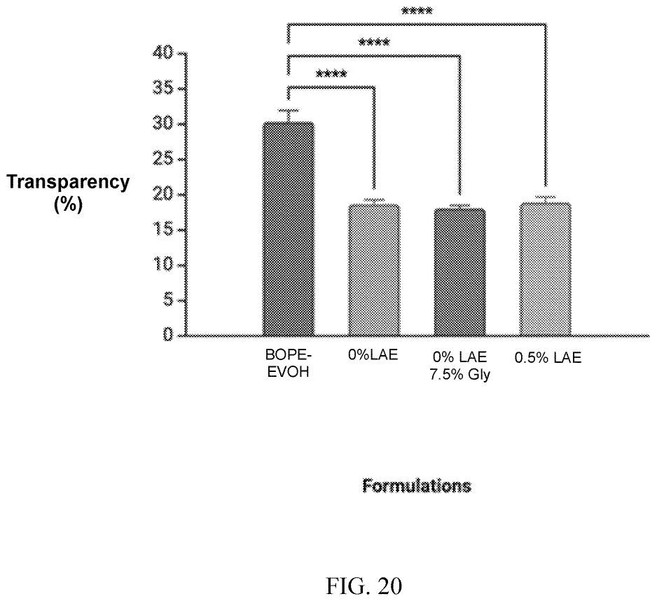

When compared to the BOPE-EVOH film, the coated films demonstrated significantly (P<0.05) reduced transparency. There were no significant differences observed between the three LAFs. The transparency of BOPE-EVOH, 0% LAE, 0% LAE 7.5% Gly, and 0.5% LAE films were 30.34, 18.66, 18.07, and 18.92%, respectively (FIG. 20). The decline in transparency and increase in film thickness is likely due to the increased in percent solids obtained by the addition of the pullulan coating.

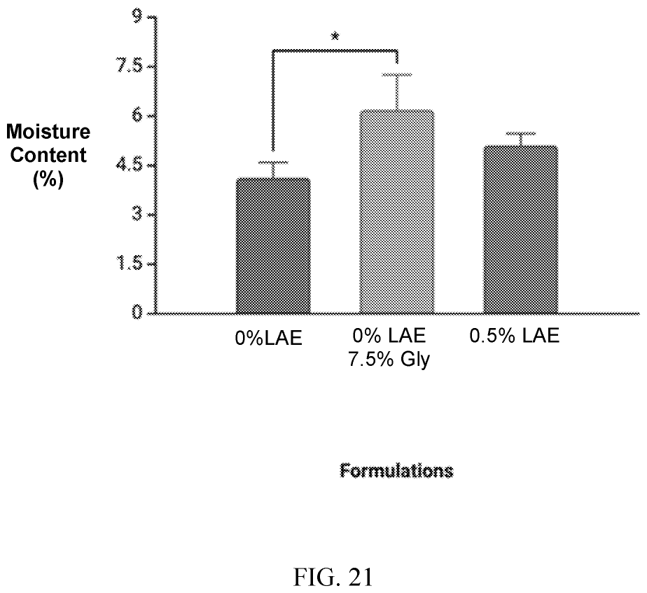

Moisture content and swelling: The moisture content of the 0% LAE, 0% LAE 7.5% Gly, and 0.5% LAE films were 4.12, 6.19, and 5.24%, respectively (FIG. 21). The moisture content of the optimized formulations showed no significant differences (P>0.05) between the LAFs containing 0.5% LAE and 0% LAE containing 7.5% glycerol content. The LAF containing 0% LAE and 7.5% glycerol content, did however demonstrated a significantly (P<0.05) higher moisture content than the LAF containing 0% LAE. This result is expected due to the humectant properties of both propylene glycol within the LAE solution and glycerol.

Glycerol contains three hydroxyl groups within a single molecule, increasing the affinity of its water-binding capacity. As a humectant, glycerol can attract moisture throughout the atmosphere through the formation of hydrogen bonds.

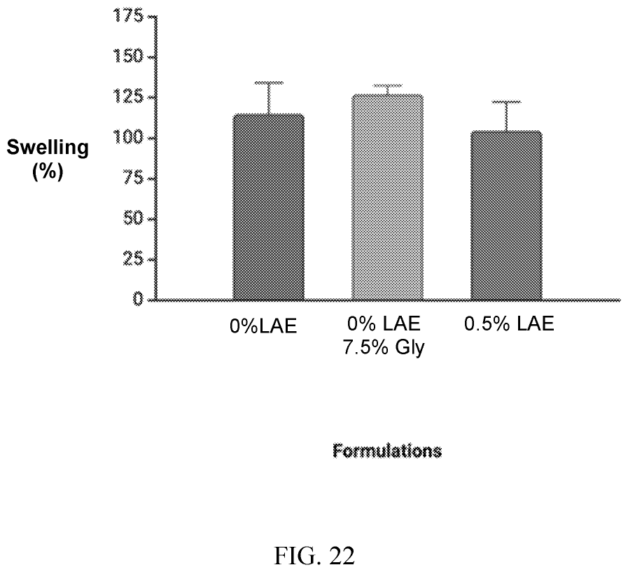

The swelling of the 0% LAE, 0% LAE 7.5% Gly, and 0.5% LAE films were 115, 127, and 104.6% respectively (FIG. 22). The results can be used to describe the swelling behavior of the films when exposed to increased relative humidity. The humidity within the environment resulted in increased weight gain amongst all three films. Pullulan and gelatin are hydroscopic polymers found to form hydrogen bonds with moisture found within the surrounding environment through the polar side groups of both polymeric chains. The interaction of moisture in the environment leads to the swelling of the polymer chains.

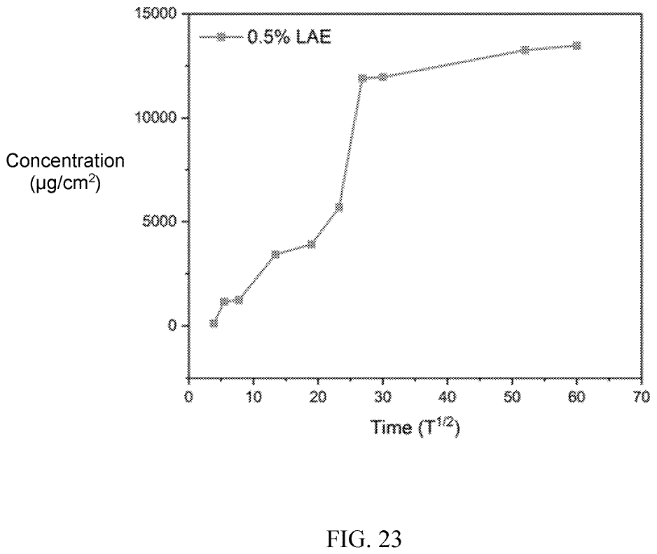

Release kinetics of the optimized LAF: When evaluating the release kinetics of potassium sorbate from gelatin and pullulan films, others have found films of pullulan and gelatin blends containing potassium sorbate to demonstrate increased swelling with increased gelatin content. When evaluating the swelling of pullulan films, they were unable to determine the swelling of films containing only pullulan due to the films rapidly dissolution when in water. The incorporation of gelatin was found to decrease the solubility of the developed films due to the partial solubility of gelatin in water below 35 °C. It was hypothesized that gelatin within the coating may improve the inhibition of LAE, due to the complexes formed or encapsulation of LAE. As gelatin is found to reduce the solubility of gelatin and pullulan films, it is possible the slow release of the antimicrobial could occur during the dissolution of the film. To determine the release kinetics of the optimized coating, the optimized LAF was evaluated using food simulant A; 10% ethanol, representing food with high water content such as meat and muscle foods. The food simulant containing the optimized film with 0.5% LAE was sampled over time to evaluate the release of LAE as a function of time. The results found the dissolution to occur in a two-phase pattern. The initial phase occurring within the initial 6 minutes resembled a burst or a quick dissolution of the polymer (FIG. 23). The following phase revealed a slower release of LAE from 6 to 60 minutes.

The initial “burst” observed in the dissolution of the LAF is commonly observed in the dissolution of biopolymers. This observation is correlated to the immediate diffusion of the polymer when immersed.

Cost analysis: The least and most expensive prices per raw material available through wholesale purchasing were used to calculate the projected cost of the LAF (Table 4). The projected cost of the LAF was found to be $0.36-2.21 per square meter (m⁻²) of film or $20.94-91.54 kg. In comparison, petroleum-based polymers commonly used in food packaging materials such as polyethylene and polypropylene are reported to cost $1.25-2.53 per kg. Common vacuum packaging bags used for food packaging can be as small 35 in² (0.02 m²) and as large as 748 in² (0.48 m²), ranging from a quantity of 1000 priced between $52.04-129.84, respectively.

TABLE 4
Cost analysis of the optimized LAF.

| | Material | | Cost of | |
|---|---|---|---|---|
| | cost per kg ($) | | LAF per m⁻² ($) | |
| Raw Material | Low | High | Low | High |
| Pullulan | 0.07 | 65.00 | 0.00 | 1.58 |
| Gelatin | 20.68 | 27.98 | 0.12 | 0.17 |
| Glycerol | 1.58 | 2.70 | 0.01 | 0.02 |
| Cytoguard (LAE) | 33.00 | 44.00 | 0.14 | 0.18 |
| BOPE-EVOH | 4.40 | 13.60 | 0.09 | 0.26 |
| Total Cost: | 59.73 | 153.28 | 0.36 | 2.21 |

Although the demand for bioplastics is increasing, the current market share falls below 1% as the cost of biopolymers largely exceeds the cost of plastics (67). As a result, food packaging innovation is often halted due to increased capital and production cost in comparison to existing technologies.

### CONCLUSIONS

This example demonstrates the scalability of the LAF within a pilot-scale process. Utilizing DOE, an optimized formulation was developed with the intent to maximize antimicrobial activity, minimize the contact angle and drying time, and fall within the target of viscosity found to reduce sagging during processing. The experimental results of the optimized formulation demonstrated reduced microbial inhibition and increased contact angle, viscosity, and drying time of the coating and optimized LAF, when compared to the predicted responses. Still, the production time of the LAF increased considerably from 24 hours of drying within a laboratory setting, to a drying time of 7.22 minutes, respectively.

The gelatin within the coating solution revealed the formation of microparticles. As microparticles have been used to encapsulate active ingredients, the increased antimicrobial activity of coatings containing increased gelatin content are believed to encapsulate LAE and therefore slow the release of the antimicrobial upon the dissolution of the film. This property is promising to the commercial applicability of the LAF, since it may extend the antimicrobial activity of the film.

It should be understood that modifications to the embodiments disclosed herein can be made to meet a particular set of design criteria. For instance, the number of or configuration of components or parameters may be used to meet a particular objective.

It will be apparent to those skilled in the art that numerous modifications and variations of the described examples and embodiments are possible in light of the above teachings of the disclosure. The disclosed examples and embodiments are presented for purposes of illustration only. Other alternative embodiments may include some or all of the features of the various embodiments disclosed herein. For instance, it is contemplated that a particular feature described, either individually or as part of an embodiment, can be combined with other individually described features, or parts of other embodiments. The elements and acts of the various embodiments described herein can therefore be combined to provide further embodiments.

It is the intent to cover all such modifications and alternative embodiments as may come within the true scope of this invention, which is to be given the full breadth thereof. Additionally, the disclosure of a range of values is a disclosure of every numerical value within that range, including the end points. Thus, while certain exemplary embodiments of the apparatus and process and/or utilization and methods of making and using the same have been discussed and illustrated herein, it is to be distinctly understood that the invention is not limited thereto but may be otherwise variously embodied and practiced within the scope of the following claims.

What is claimed is:

1. An antimicrobial layer comprising:
an antimicrobial coating formed from a biopolymer solution comprising:
at least one antimicrobial agent present in an amount up to 5 wt %,
at least one polysaccharide present in an amount between 12-15 wt %,
at least one protein present in an amount up to5 wt %,
at least one plasticizer present in an amount up to 10 wt %, and
water present in an amount between 70-80 wt %;
a plastic film comprising one or more plastics,
wherein at least a portion of the antimicrobial coating is disposed on at least a portion of the plastic film.

2. The layer of claim 1, wherein the at least one antimicrobial agent comprises ethyl lauric arginate.

3. The layer of claim 1, wherein the at least one polysaccharide comprises pullulan.

4. The layer of claim 1, wherein the at least one polysaccharide consist of pullulan.

5. The layer of claim 1, wherein the antimicrobial coating does not include xanthan gum.

6. The layer of claim 1, wherein the at least one protein comprises gelatin.

7. The layer of claim 1, wherein the at least one plasticizer comprises glycerol.

8. The layer of claim 1, wherein the one or more plastics comprise ethylene vinyl alcohol.

9. A film comprising the antimicrobial layer of claim 1.

10. The film of claim 9, wherein the antimicrobial layer is disposed on a food packaging material that is in contact with a food product.

11. The film of claim 10, wherein at least a portion of the antimicrobial coating is in contact with the surface of the food product.

12. The film of claim 10, wherein the film is configured to inhibit growth of at least one microorganism on the food product.

13. The film of claim 12, wherein the film is configured to increase the shelf life of the food product relative to the shelf life of the food product packaged with a comparative layer different than the antimicrobial layer.

14. The film of claim 12, wherein the film is configured to inhibit growth of the at least one microorganism for a period of up to 28 days under refrigeration conditions.

15. A vacuum sealed bag comprising the antimicrobial layer of claim 1.

16. A method of forming an antimicrobial layer, the method comprising:
providing a plastic film comprising one or more plastics;
depositing a biopolymer solution onto the plastic film, the biopolymer solution comprising:
at least one antimicrobial agent present in an amount up to 5 wt %,
at least one polysaccharide present in an amount between 12-15 wt %,
at least one protein present in an amount up to 5 wt %,
at least one plasticizer present in an amount up to 10 wt %, and
water present in an amount between 70-80 wt %; and
drying the biopolymer solution to form an antimicrobial coating.

17. The method of claim 16, further comprising:
corona-treating the plastic film prior to depositing the biopolymer solution onto the plastic film.

18. The method of claim 16, wherein drying the biopolymer composition comprises infrared heating the biopolymer solution.

19. The method of claim 18, wherein drying the biopolymer composition further comprises subjecting the biopolymer solution to an air velocity of at least 12 m/s.

20. The method of claim 16, wherein the biopolymer solution is configured to be dried within 10 minutes.
